(19) United States
(12) Patent Application Publication
(10) Pub. No.: US 2002/0194346 A1
(43) Pub. Date: Dec. 19, 2002

(54) System and method for transmitting data via the internet by means of a tcp/ip connection as a semaphore

(76) Inventor: Thomas Talanis, Heroldsbach (DE)

Correspondence Address: STAAS & HALSEY LLP, 700 11TH STREET, NW, SUITE 500, WASHINGTON, DC, 20001, US

(21) Appl. No.: 10/169,828

(22) PCT Filed: Dec. 28, 2000
(86) PCT No.: PCT/DE00/04661

(30) Foreign Application Priority Data
Jan. 11, 2000 (DE) 100-00-757.0

(51) Int. Cl. G06F 15/16

(52) U.S. Cl. 709/227

(57) ABSTRACT

A system and a method transmit data via the internet between at least one client and at least one server, especially for operating and observing an automation system (remote unit). An internet semaphore, when received, indicates a connection is successfully established between a client and the server. It is thus guaranteed that the clients are synchronized on the server, i.e., at any time, one client only has, especially writing, access to the server.

### CROSS REFERENCE TO RELATED APPLICATIONS

This application is based on and hereby claims priority to PCT Application No. PCT/DE00/04661 filed on Dec. 28, 2000 and German Application No. 100 00 757.0 filed on Jan. 11, 2000, the contents of which are hereby incorporated by reference.

### BACKGROUND OF THE INVENTION

The invention relates to a system for transmitting data via the Internet between at least one client and at least one server.

The invention also relates to a method for transmitting data via the Internet between at least one client and at least one server, to a server for setting up a data link via the Internet to at least one client, and to a computer program [product] for a server for setting up a data link via the Internet to at least one client.

### SUMMARY OF THE INVENTION

[The]One aspect of the invention is based on the object of ensuring a semaphore which is valid throughout the network and which can also be used securely for critical operations between the client and the server.

This object [is]may be achieved by a system for transmitting data via the Internet between at least one client and at least one server, the server having a special resource[means for setting]unit to set up precisely one passive connection between the server and precisely one client for performing critical operations between the server and the client, and where successful connection setup between the client with which the connection setup was successful and the server is assessed as receipt of the Internet semaphore.

This object [is]may be achieved by a method for transmitting data via the Internet between at least one client and at least one server, in which the server provides a special resource [means for setting]unit to set up precisely one passive connection between the server and precisely one client for performing critical operations between the server and the client, and in which successful connection setup between the client with which the connection setup was successful and the server is assessed as receipt of the Internet semaphore.

This object [is]may be achieved by a server for setting up a data link via the Internet to at least one client, where the server has a control [means]unit and a special resource [means for setting] unit to set up precisely one passive connection between the server and precisely one client for performing critical operations between the server (lacuna), which cause successful connection setup between the client with which the connection setup was successful and the server to be assessed as receipt of the Internet semaphore.

This object [is]may be achieved by a computer program [product] for a server for setting up a data link via the Internet to at least one client, where the server has a control [means]unit for setting up precisely one passive connection between the server and precisely one client for performing critical operations between the server and the client, where the control [means cause]unit causes successful connection setup between the client with which the connection setup was successful and the server to be assessed as receipt of the Internet semaphore.

[The]One aspect of the invention is based on the insight that most operating systems do not provide semaphores which are valid throughout the network. Particularly in the case of critical operations, such as when a client is involved in write access to a server, this can result in the client not being able to access an application on the server explicitly. If, by contrast, the server holds special [resource means]resources for setting up precisely one passive connection between the server and precisely one client, and if successful connection setup between the client and the server is assessed as receipt of the Internet semaphore, then this produces the effect of a semaphore which is valid throughout the network. The result of this is that only one client has writing rights which ensure synchronization between a plurality of clients and the server. From a practical point of view, this merely requires resources for passive setup of precisely one connection to be provided on the server. As a request for the semaphore, the client starts a connection setup attempt. Successful setup of the connection is assessed as receipt of the semaphore. The client can now perform critical operations. If the client wishes to deliver the semaphore again, it clears down the connection.

Automatic “clearing” of the server for fresh access by a client can be ensured by virtue of the server having a control [means]unit which, following successful connection setup and failure of the client with which the connection setup was successful and/or failure of the connection, [cause]causes the connection to be assessed as cleared down, and cause the special resource [means]unit to become free again.

A time limit can be put on the duration of a connection between the client and the server by virtue of the server having a time monitoring [means]unit which, following successful connection setup and after a prescribable time period has elapsed, [cause]causes the connection to be cleared down and cause the special resource [means]unit to become free again.

A particularly advantageous application, using available Internet infrastructures for secure write access to a server, involves the system being intended for operating and observing an automation system via the Internet.

A connection between automation technology and communications technology can easily be in a form such that the client has an operating and observation system for operating and observing an automation system, where the client initiates the provision of the transmission channels as a distributed object, particularly as a Distributed Component Object Model (DCOM) object, and where connections are set up to the automation system via a DCOM server.

### BRIEF DESCRIPTION OF THE DRAWINGS

[The invention is described and explained in more detail below with reference to the exemplary embodiments illustrated in the figures, in which:]These and other objects and advantages of the present invention will become more apparent and more readily appreciated from the following description of the preferred embodiments, taken in conjunction with the accompanying drawings of which:

FIG. 1 shows a block diagram of a basic illustration of a system for transmitting data via the Internet by [means of] a TCP/IP connection as a semaphore,

FIG. 2 shows a schematic illustration of the timing of connection setup and connection cleardown between the client and the server,

FIG. 3 shows another exemplary embodiment of a system for transmitting data via the Internet from a plurality of client to a server using an Internet connection, and

FIG. 4 shows a block diagram of an exemplary embodiment of an automation system with Internet coupling.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

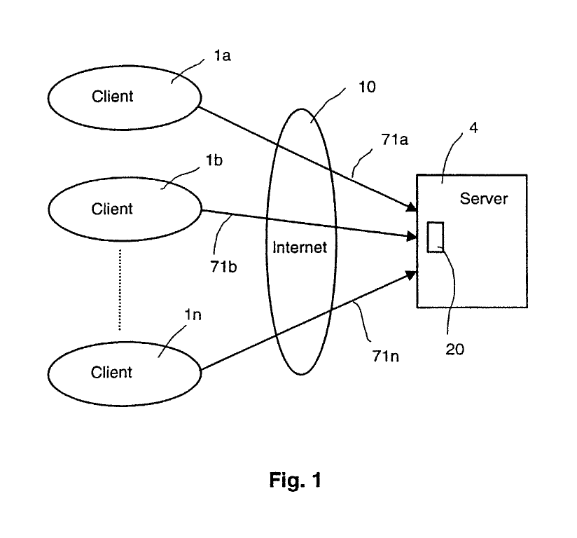

FIG. 1 shows a block diagram of a basic illustration of a system for transmitting data via the Internet by [means of] a TCP/IP connection (TCP=Transport Control Protocol, IP=Internet Protocol) as an Internet semaphore. The system shown in FIG. 1 comprises a plurality of clients 1a . . . 1n which can set up connections 71a . . . 71n to a server 4 via the Internet 10. The server 4 contains a special resource [means]unit 20 [for setting]to set up precisely one passive connection between the server 4 and precisely one client 1a . . . 1n.

In the case of the system shown in FIG. 1, having a server 4 and a plurality of clients 1a . . . 1n, it is often necessary for the clients 1a . . . 1n to be synchronized for access to the server 4. Particularly for write access to the server 4, it is necessary to ensure that only one client 1a . . . 1n has write authorization at a time. Such synchronization is normally effected using a “semaphore”. Most operating systems have the problem, however, that they do not provide semaphores which are valid throughout the network. The problem of ensuring a semaphore which is valid throughout the network is solved surprisingly easily in FIG. 1 by virtue of a TCP/IP connection being used as a semaphore. This merely requires providing resources 20 for passive setup of precisely one connection on the server 4. As a request for the semaphore, a client, for example the client 1a in FIG. 1, starts a connection setup attempt via the connection 71a of the Internet 10. Successful setup of the connection 71a is assessed as receipt of the semaphore. The client 1a, which has now set up a valid connection to the server 4, can now perform the critical operations. The connection 71a can be cleared down by virtue of the client 1a clearing down a connection and hence delivering the semaphore again, i.e. the [resource means]resources 20 are available for fresh connection setup by the clients 1a . . . 1n. In addition, the use of a TCP/IP connection as an Internet semaphore affords the following advantages:

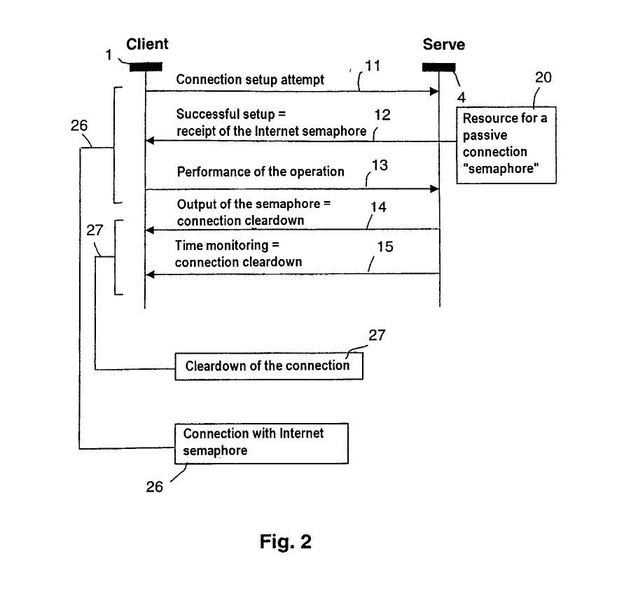

If the client 1a . . . 1n fails or if the connection 71a. . . 71n to the client 1a . . . 1n fails, the server 4, identifies the connection 71a . . . 71n as cleared down after a particular prescribable time, as a result of which the semaphore [20] becomes free again. Time monitoring also makes it possible to ensure that the client 1a . . . 1n is given the semaphore [20] only for a particular period of time. Once the time has elapsed, the server 4 automatically clears down the connection. FIG. 2 shows a schematic illustration of the timing for connection setup and connection cleardown between a client 1 and a server 4. In this context, the client 1 starts a connection setup attempt 11 as requests for the semaphore. Successful setup of the connection is assessed as receipt of the semaphore in step 12. In a step 13, the client can now perform operations, particularly operations critical to synchronism. Steps 14 and 15 identify that by delivering the semaphore or by [means of] time monitoring, connection setup and hence release of the resource unit 20 in the server 4 can be ensured. This is summarized in block 27 by [means of] the entry “cleardown of the connection”, while connection setup and transfer of the Internet semaphore are summarized in block 26.

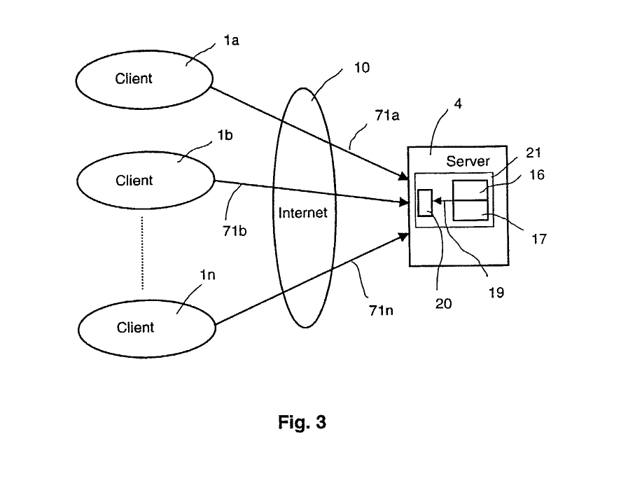

FIG. 3 shows another block diagram of a basic illustration of a system for transmitting data via the Internet from a client 1a . . . 1n to a server 4 via Internet connections 71a . . . 71n. The reference 10 again identifies the Internet. The server contains the resource [means]unit 20 for setting up precisely one passive connection between the server 4 and precisely one client 1a . . . 1n. The special resource [means]unit 20 [are]is part of a computer program [product] 21, which additionally has a control [means]unit 16 and a time monitoring [means]unit 17. The control [means]unit 16 and the time monitoring [means]unit 17 actuate the resource [means]unit 20 via a control connection identified as arrow 19 in FIG. 3.

The system shown in FIG. 3 essentially corresponds to the system already explained in connection with FIG. 1, so that reference is made to the statements shown in FIG. 1 in order to explain the basic principle. The computer program [product] 21, which is a software program which can be executed on the server 4, for example, firstly contains the special resource [means for setting]unit to set up precisely one passive connection between the server 4 and precisely one client 1a . . . 1n, the control [means 21]unit 16 additionally [causing]causes successful connection setup between the client 1a . . . 1n and the server 4 to be assessed as receipt of the Internet semaphore. In addition, the control [means]unit 16 [are]is intended to cause successful connection setup and failure of the client with which connection setup was successful and/or failure of the connection to be followed by the connection being assessed as cleared down, and by the special resource [means]unit 20 becoming free again. The time monitoring [means]unit 17 of the computer program [product] 21 [are]is used to ensure that, following successful connection setup and following the elapsing of a prescribable time period, the connection 71a . . . 71n is cleared down and the special resource [means]unit 20 likewise [become]becomes free again.

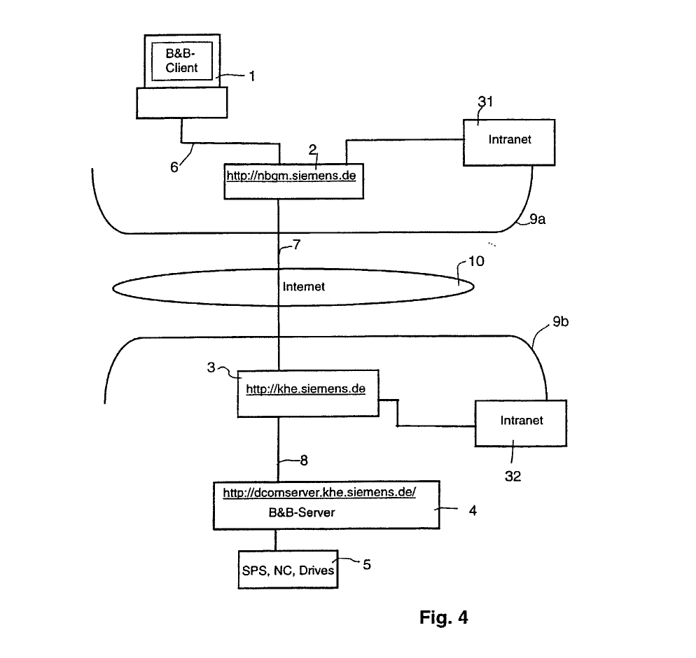

FIG. 4 shows an exemplary embodiment of a system for operating and observing automation systems 5 (a remote unit) which, by way of example, have programmable logic controllers (SPS), numerical controllers (NC) and/or drives (Drives). The system has an operating and observation system 1 (B&B client) which is coupled to a firewall computer 2 (=Proxy) via an internal data network 6, e.g. Ethernet. The operating and observation system 1, which is also referred to below as B&B system for short, has an associated local intranet address which is not necessarily known on the Internet. Using the line 9a, FIG. 1 indicates the firewall of the firewall computer 2, which surrounds the internal communications network 31 (=Intranet 31 ) of the firewall server 3. The reference 10 identifies the worldwide data communications network, the Internet. The firewall computer 2 can be coupled to the Internet 10 via a connecting line 7, e.g. ISDN. The automation system 5 can be coupled to the Internet 10 by [means of] a connecting line 8 and a respective second firewall computer 3 via an Internet server 4, which serves as B&B server for the automation system 5 and has the Internet address dcomserver.khe.siemens.de/. The second firewall computer 3 surrounds the intranet 32 associated with the firewall computer 3 and can be viewed on the Internet 10 at the Internet address khe.siemens.de.

The exemplary embodiment shown in FIG. 4 shows, as application case, a client which contains an operating and observation system and permits communication with the server 4 of the automation system 5 via the connections 6, 7, 8, i.e. via the first firewall computer 2, via the Internet 10 and via the second firewall computer 3. As already explained in connection with FIG. 1 to FIG. 3, the server 4 holds the special resource [means]unit for setting up precisely one passive connection between the server 4 and the client 1. Upon successful connection setup via the connections 6, 7, 8 from the client 1 to the server 4, the successful connection setup between the client 1 and the server 4 is again assessed as receipt of the Internet semaphore. This results in explicit synchronization between the client 1 and the server 4, which, particularly in the case of an instance of application in the field of automation technology, is of great importance for controlling or for operating and observing the automation system 5. While there is a valid connection between the client 1 and the server 4, other clients (which are not shown in more detail in FIG. 1 for reasons of clarity) cannot set up a write connection, at least, to the operating and observation server 4. Only when the connection between the client 1 and the server 4 has been cleared down is the semaphore delivered again and the connection between client 1 and server 4 cleared down. The client 1 or another client can then access the server 4 again.

In summary, one aspect of the invention thus relates to a system and a method for transmitting data via the Internet by [means of] a TCP/IP connection as a semaphore between at least one client 1a . . . 1n and at least one server 4. To ensure an Internet semaphore which is valid throughout the network, it is proposed that the server 4 has the resource [means]unit 20 for a connection, with a successful connection setup between a client 1a . . . 1n and the server 4 being assessed as receipt of the Internet semaphore. This ensures that the clients 1 . . . 1n are synchronized to the server, i.e. that just a single client 1a . . . 1n has write access, in particular, to the server 4 at any time.

The invention has been described in detail with particular reference to preferred embodiments thereof and examples, but it will be understood that variations and modifications can be effected within the spirit and scope of the invention.

1. A system for transmitting data via the Internet (10) between at least one client (1a . . . 1n) and at least one server (4), the server (4) having special resource means (20) for setting up precisely one passive connection between the server (4) and precisely one client (1a . . . 1n) for performing critical operations between the server (4) and the client (1a . . . 1n), and where successful connection setup (12) between the client (1a . . . 1n) with which the connection setup was successful and the server (4) is assessed as receipt of the Internet semaphore (12).

2. The system as claimed in claim 1,
characterized
in that the server (4) has a control apparatus (16) which, following successful connection setup (12) and failure of the client (1a . . . 1n) with which the connection setup was successful and/or failure of the connection, cause the connection to be assessed as cleared down and cause the special resource means (20) to become free again.

3. The system as claimed in one of claims 1 or 2,
characterized
in that the server has time monitoring means (17) which, following successful connection setup (12) and after a prescribable time period has elapsed, cause the connection (71a . . . 71n) to be cleared down and cause the special resource means (20) to become free again.

4. The system as claimed in one of claims 1 to 3,
characterized
in that the system is intended for operating and observing an automation system (5) via the Internet (10).

5. The system as claimed in one of claims 1 to 4,
characterized
in that the client (1a . . . 1n) has an operating and observation system for operating and observing an automation system (5), where the client (1a . . . 1n) initiates the provision of the transmission channels (71a . . . 71n) as a distributed object, particularly as a DCOM object, and where connections are set up to the automation system (5) via a DCOM server (4).

6. A method for transmitting data via the Internet (10) between at least one client (1a . . . 1n) and at least one server (4) , in which the server (4) provides special resource means (20) for setting up precisely one passive connection between the server (4) and precisely one client (1a . . . 1n) for performing critical operations between the server (4) and the client (1a . . . 1n) , and in which successful connection setup (12) between the client (1a . . . 1n) with which the connection setup was successful and the server (4) is assessed as receipt of the Internet semaphore (12).

7. The method as claimed in claim 6,
characterized
in that, following successful connection setup (12) and failure of the client (1a . . . 1n) with which the connection setup was successful and/or failure of the connection, the connection is assessed as cleared down and the special resource means (20) become free again.

8. The method as claimed in one of claims 6 or 7,
characterized
in that time monitoring means (17) on the server (4) cause successful connection setup (12) and the elapsing of a prescribable time period to be followed by cleardown of the connection (71a . . . 71n) and the special resource means (20) becoming free again.

9. The method as claimed in one of claims 6 to 8,
characterized
in that the method for operating and observing an automation system (5) is provided via the Internet (10).

10. The method as claimed in one of claims 6 to 9,
characterized
in that the operating and observation system on the client (1) initiates provision of the transmission channels (71a . . . 71n) as a distributed object, particularly as a DCOM object, and in that connections are setup to the automation system (5) via a DCOM server (4).

11. A server (4) for setting up a data link via the Internet (10) to at least one client (1a . . . 1n) , where the server (4) has special resource means (20) for setting up precisely one passive connection between the server (4) and precisely one client (1a . . . 1n) for performing critical operations between the server (4) [lacuna] control means (16) which cause successful connection setup (12) between the client (1a . . . 1n) with which the connection setup was successful and the server (4) to be assessed as receipt of the Internet semaphore (12).

12. The server as claimed in claim 11,
characterized
in that the server (4) [lacuna] the control means (16) are additionally provided to cause successful connection setup (12) and failure of the client (1a . . . 1n) with which the connection setup was successful and/or failure of the connection to be followed by the connection being assessed as cleared down, and the special resource means (20) becoming free again.

13. The server as claimed in one of claims 11 or 12,
characterized
in that the server (4) has time monitoring means (17) which, following successful connection setup (12) and when a prescribable time period has elapsed, cause the connection (71a . . . 71n) to be cleared down and cause the special resource means (20) to become free again.

14. The server as claimed in one of claims 11 to 13,
characterized
in that the server (4) is intended for operating and observing an automation system (5) via the Internet (10).

15. The server as claimed in one of claims 11 to 14,
characterized
in that the server (4) is in the form of a DCOM server (4), where the operating and observation system on the client (1a . . . 1n) initiates provision of the transmission channels (71a . . . 71n) as a distributed object, particularly as a DCOM object.

16. A computer program product (21) for a server (4) for setting up a data link via the Internet (10) to at least one client (1a . . . 1n), where the server (4) has control means (16) for setting up precisely one passive connection between the server (4) and precisely one client (1a . . . 1n) for performing critical operations between the server (4) and the client (1a . . . 1n), where the control means (20) cause successful connection setup (12) between the client (1a . . . 1n) with which the connection setup was successful and the server (4) to be assessed as receipt of the Internet semaphore (12).

17. The computer program product as claimed in claim 16,
characterized
in that the control means (16) are additionally provided to cause successful connection setup (12) and failure of the client (1a . . . 1n) with which the connection setup was successful and/or failure of the connection to be followed by the connection being assessed as cleared down and by the special resource means (20) becoming free again.

18. The computer program product as claimed in one of claims 16 or 17,
characterized
in that the computer program product (21) has time monitoring means (17) which cause successful connection setup (12) and the elapsing of a prescribable time period to be followed by cleardown of the connection (71a . . . 71n), and the special resource means (20) becoming free again.

19. The computer program product as claimed in one of claims 16 to 18,
characterized
in that the computer program product is intended for operating and observing an automation system (5) via the Internet (10).
